(19) United States
(12) Patent Application Publication
(10) Pub. No.: US 2025/0031881 A1
(43) Pub. Date: Jan. 30, 2025

(54) Device made of semi rigid material with suction producing base, a void for liquid or other object(s), and Internal Markings To Measure Amount Of Liquid In Void.

(71) Applicants: Joseph Losito, Olathe, KS (US); Adam Setterburg, Stamford, CT (US)

(72) Inventors: Joseph Losito, Olathe, KS (US); Adam Setterburg, Stamford, CT (US)

(21) Appl. No.: 18/357,980

(22) Filed: Jul. 24, 2023

(51) Int. Cl. A47G 19/22

(52) U.S. Cl. CPC A47G 19/2261; F16B 47/00; G01F 19/00

(57) ABSTRACT

A semi rigid device with suction producing base, a void for liquid or other object(s), and internal Markings To Measure Amount Of Liquid In Void.

This non-provisional application claims the benefit of provisional application No. 63/482,998 filed Feb. 23, 2023.

### BACKGROUND

When using a traditional item such as U.S. Pat. No. 5,772,065A a user may find difficulty in keeping the “shot glass” in place for a number of activities. At the same time, the traditional “shot glass” is constructed of glass or plastic. These materials can be fragile and can break during transportation, as addressed in U.S. Pat. No. 8,469,225B2. Furthermore, users may need to measure a specific volume of liquid to ensure proper portioning. To solve these issues, the need for a semi rigid liquid receptacle which can adhere to surfaces and hold its shape when in use, while being deformable when not in use, and marked with measuring indicators arises.

### SUMMARY

To attach the semi rigid liquid receptacle to a variety of surfaces, our invention utilizes an integrated suction cup at the base of a deformable liquid receptacle. The suction cup will allow the device to stay in place in any configuration while suctioned to a surface. The semi rigid receptacle void will allow liquid or other object(s) to be placed and held inside the void's open where and when gravity allows. The internal markings can either be cut into the surface, extruded from the surface, or printed on the surface and are used to measure the contents in the void or can be ornamental in nature. This allows for containment of a specified volume of liquid or other objects until the user decides to dispense the liquid or other object(s).

### BRIEF DESCRIPTION OF THE DRAWINGS

FIG. 1 is a top, front, perspective view of a lid showing the new design;

FIG. 2 is a bottom, front perspective view thereof;

FIG. 3 is a right view thereof; wherein the left view is a mirror image of FIG. 3

FIG. 4 is a top view thereof; with a callout for the sectional view represented in FIG. 6

FIG. 5 is a bottom view thereof, and;

FIG. 6 is a sectional view, with broken lines showing the liquid storage area (4), recessed measuring markings (2), and suction cup base of our new design (6);

### DETAILED DESCRIPTION OF THE PREFERRED EMBODIMENTS

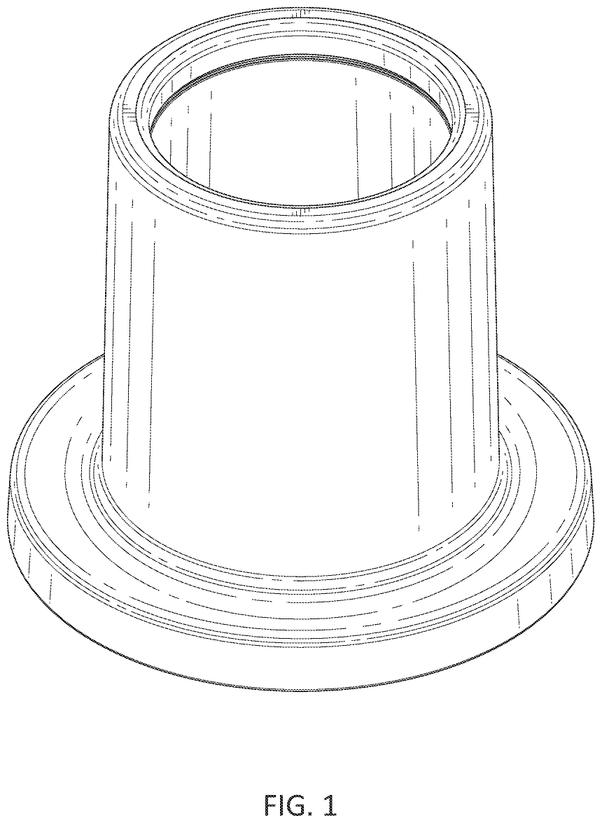

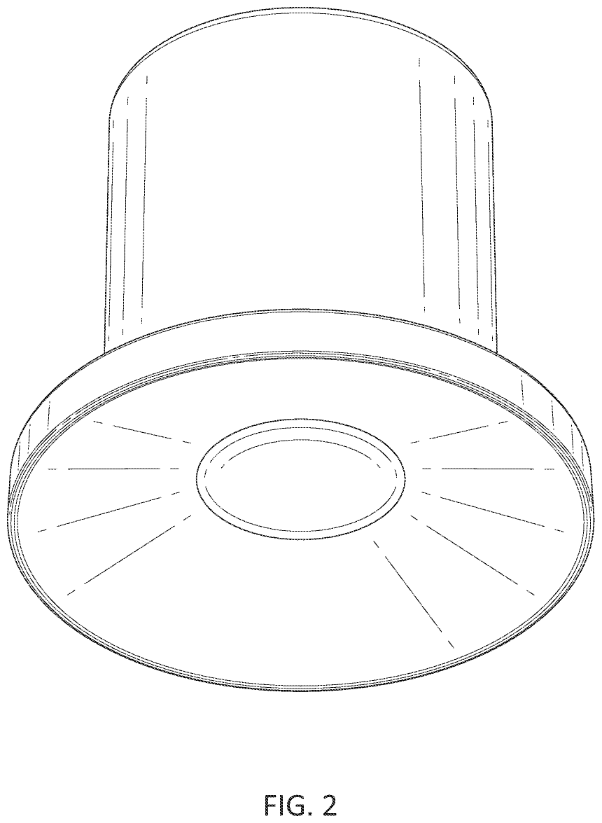

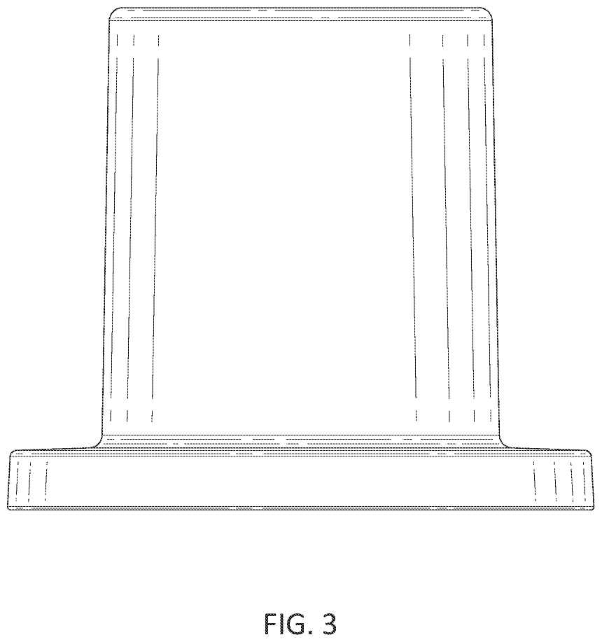

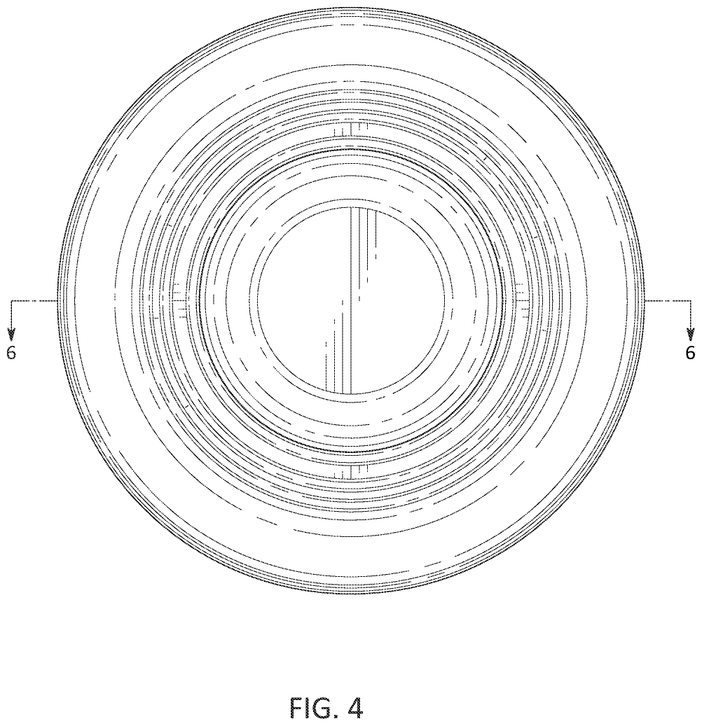

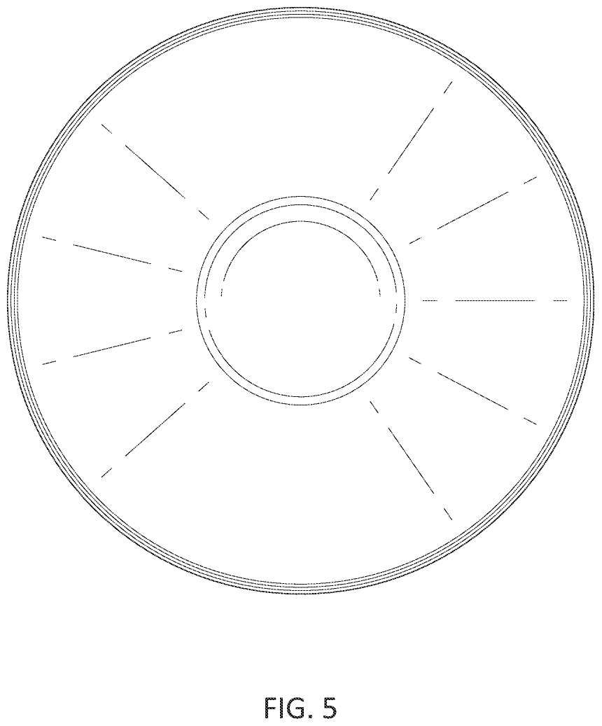

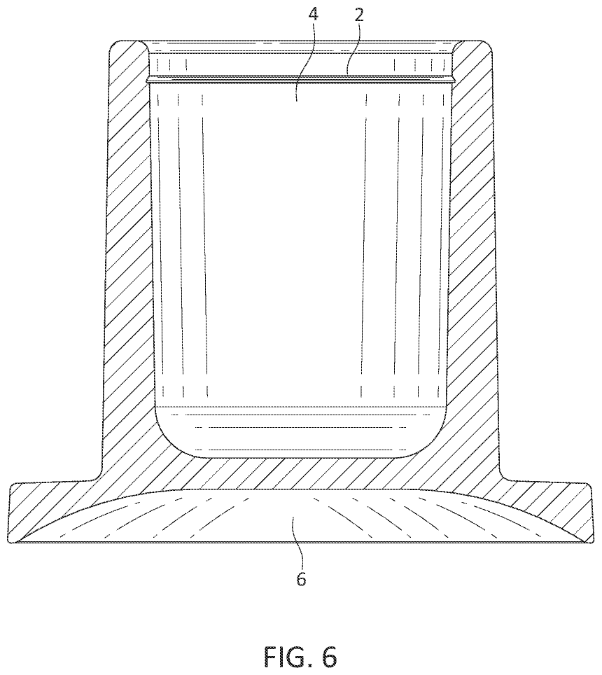

Referring now to FIGS. 1-6, there is illustrated a preferred embodiment of the device made of semi rigid material with suction producing base, a void for liquid or other object(s), and internal markings to measure the amount of liquid in void.

The present device shown in the accompanying drawings, has three distinct features: The receptacle void, 4, will allow liquid or other object(s) to be placed and held inside the void's open where and when gravity allows. The internal markings, 2, can either be cut into the surface, extruded from the surface, or printed on the surface and are used to measure the contents in the void or can be ornamental in nature. The suction cup, 6, is integrated into the base of the device and will allow the device to stay in place in any configuration while suctioned to a surface.

What is claimed is:

1. A unitary, non-fragile, self-anchoring liquid container comprising:
a base fabricated of non-fragile, elastic material and configured to suction attach to a reference surface; and
a sidewall fabricated of non-fragile, elastic material and which extends from the base to form a receptacle for holding liquid, wherein the sidewall has an interior surface and an exterior surface, and
wherein a marking is formed along its interior surface for indicating the volume of a held liquid.

2. The container of claim 1, wherein said marking is a surface topography irregularity along said sidewall interior surface.

3. The container of claim 2, wherein said marking is a protrusion along said sidewall interior surface.

4. The container of claim 2, wherein said marking is an indentation within said sidewall interior surface.

5. The container of claim 1, wherein said base and sidewall are fabricated of silicone

6. The container of claim 1, wherein said base is a suction cup.
